(19) United States
(12) Patent Application Publication
(10) Pub. No.: US 2009/0293457 A1
(43) Pub. Date: Dec. 3, 2009

(54) System and method for controlling NOx reactant supply

(76) Inventors: Anthony J. Grichnik, Peoria, IL (US); Amit Jayachandran, Peoria, IL (US); Mary L. Kesse, Hanna City, IL (US); James Mason, Peoria, IL (US); Tim Felty, Peoria, IL (US)

Correspondence Address: CATERPILLAR/FINNEGAN, HENDERSON, L.L.P., 901 New York Avenue, NW, WASHINGTON, DC, 20001-4413, US

(21) Appl. No.: 12/155,196

(22) Filed: May 30, 2008

(51) Int. Cl. F01N 3/20; F02B 51/02; G06G 7/70

(52) U.S. Cl. 60/286; 60/301; 701/108

(57) ABSTRACT

A method is provided for a selective catalytic reduction (SCR) system for reducing a pollutant emission level in exhaust gas of an engine on a machine. The method may include providing a plurality of virtual sensors each having a model type, at least one input parameter, and at least one output parameter. The plurality of virtual sensors may include a first virtual sensor for measuring an emission level of a first component the pollutant and a second virtual sensor for measuring an emission level of a second component the pollutant. The method may also include integrating the plurality of virtual sensors into a virtual sensor network; operating the virtual sensor network to provide the first component emission level and the second component emission level; and calculating a ratio between the first component and the second component based on the first component emission level and the second component emission level. Further, the method may include determining a reactant injection rate of a reactant of the SCR system based on the ratio; and controlling the SCR system to apply the reactant at the reactant injection rate to reduce the pollutant emission level to a desired range.

### TECHNICAL FIELD

This disclosure relates generally to engine emission control techniques and, more particularly, to computer based virtual sensor network based engine emission control systems and methods.

### BACKGROUND

Physical sensors are widely used in emissions from motor vehicles. Physical sensors often take direct measurements of the physical phenomena and convert these measurements into measurement data to be further processed by control systems. Although physical sensors take direct measurements of the physical phenomena, physical sensors and associated hardware are often costly and, sometimes, unreliable. Further, when control systems rely on physical sensors to operate properly, a failure of a physical sensor may render such control systems inoperable. For example, the failure of an intake manifold pressure sensor in an engine may result in shutdown of the engine entirely even if the engine itself is still operable.

Instead of direct measurements, virtual sensors have been developed to process other various physically measured values and to produce values that were previously measured directly by physical sensors. Further, a modern machine may need multiple sensors to function properly, and multiple virtual sensors may be used. However, conventional multiple virtual sensors are often used independently without taking into account other virtual sensors in an operating environment, which may result in undesired results. For example, multiple virtual sensors may compete for limited computing resources, such as processor, memory, or I/O, etc. An output of one virtual sensor model could also inadvertently becomes an input to another virtual sensor model, which can result in unpredictable effects in complex control systems relying on these values. Further, other types of interactions among the multiple virtual sensors may cause undesired or unpredictable results, such as feedback loops or transient control instabilities.

In applications associated with internal combustion engines, including diesel engines and gasoline engines, engine exhaust emission may include gaseous compounds such as, for example, nitrogen oxides (NOx). Due to increased awareness of the environment, exhaust emission standards have become more stringent, and the amount of NOx emitted from an engine may be regulated depending on the type of engine, size of engine, and/or class of engine.

The NOx emission level may be reduced or controlled by selective catalytic reduction (SCR) of NOx. SCR is a means of converting NOx with the aid of a catalyst or a reactant into diatomic nitrogen, N₂, and water, H₂O. To determine the amount of reactant to use, physical NOx sensors are often used to measure NOx emission level. For example, U.S. Pat. No. 7,178,328 issued Feb. 20, 2007, to Solbrig et al. discloses a reductant dosing control system based on a feedback signal from a physical NOx sensor placed before the SCR system.

However, conventional techniques based on physical NOx sensors are often incapable of distinguishing various NOx components, such as NO and NO₂, etc., in the NOx emission such that efficient and precise use of SCR reactants may be difficult to achieve. Further, conventional reactant control system may often need multiple NOx sensors, such as NOx sensors placed before and after the SCR system, which may significantly increase complexity and cost of the SCR system. Moreover, certain NOx/NO/NO₂ physical sensor systems are often impractical for being used on mobile machines or in real-time applications.

Methods and systems consistent with certain features of the disclosed systems are directed to solving one or more of the problems set forth above.

### SUMMARY

One aspect of the present disclosure includes a method for providing a selective catalytic reduction (SCR) system for reducing a pollutant emission level in exhaust gas of an engine on a machine. The method may include providing a plurality of virtual sensors each having a model type, at least one input parameter, and at least one output parameter. The plurality of virtual sensors may include a first virtual sensor for measuring an emission level of a first component of the pollutant and a second virtual sensor for measuring an emission level of a second component of the pollutant. The method may also include integrating the plurality of virtual sensors into a virtual sensor network; operating the virtual sensor network to provide the first component emission level and the second component emission level; and calculating a ratio between the first component and the second component based on the first component emission level and the second component emission level. Further, the method may include determining a reactant injection rate of a reactant of the SCR system based on the ratio; and controlling the SCR system to apply the reactant at the reactant injection rate to reduce the NOx emission level to a desired range.

Another aspect of the present disclosure includes a method for monitoring an SCR system provided for reducing a pollutant emission level in exhaust gas of an engine on a machine. The method may include providing a plurality of virtual sensors each having a model type, at least one input parameter, and at least one output parameter. The plurality of virtual sensors may include a first virtual sensor for measuring an emission level of a first component the pollutant and a second virtual sensor for measuring an emission level of a second component of the pollutant. The method may also include integrating the plurality of virtual sensors into a virtual sensor network; operating the virtual sensor network to provide the first component emission level and the second component emission level; and obtaining a pollutant emission level of the exhaust gas from a physical sensor. Further, the method may include calculating a difference between the pollutant emission level from the physical sensor and a combination of the first component emission level and the second component emission level; and determining status information of a reactant of the SCR system based on the difference to control operation of the SCR system.

Another aspect of the present disclosure includes a mobile machine. The machine may include an engine to provide power for the machine and an SCR system for reducing a pollutant emission level in exhaust gas of the engine. The machine may also include a control system for controlling the engine and the SCR system and a plurality of physical sensors providing sensing data to the control system. Further, the machine may include a virtual sensor network system for providing predicted sensing data to the control system. The virtual sensor network system may include a plurality of virtual sensors each having a model type, at least one input parameter, and at least one output parameter. Further, the plurality of virtual sensors may include a first virtual sensor for measuring an emission level of a first component of the pollutant and a second virtual sensor for measuring an emission level of a second component of the pollutant. The control system is configured to operate the virtual sensor network to provide the first component emission level and the second component emission level; and to calculate a ratio between the first component and the second component based on the first component emission level and the second component emission level. Further, the control system may be configured to determine a reactant injection rate of a reactant of the SCR system based on the ratio; and to control the SCR system to apply the reactant at the reactant injection rate to reduce the pollutant emission level to a desired range.

### BRIEF DESCRIPTION OF THE DRAWINGS

FIG. 1 illustrates an exemplary block diagram of a machine in which features and principles consistent with certain disclosed embodiments may be incorporated;

FIG. 2 illustrates a logical block diagram of an exemplary computer system consistent with certain disclosed embodiments;

FIG. 3 illustrates a block diagram of an exemplary virtual sensor network system consistent with certain disclosed embodiments;

FIG. 4 shows a flow chart of an exemplary virtual sensor integration process consistent with certain disclosed embodiments;

FIG. 5 illustrates a flowchart diagram of an exemplary virtual sensor network operational process consistent with certain disclosed embodiments;

FIG. 6 illustrates a flow chart diagram of an exemplary urea controlling process consistent with certain disclosed embodiments; and

FIG. 7 illustrates a flow chart diagram of an exemplary urea monitoring process consistent with certain disclosed embodiments.

### DETAILED DESCRIPTION

Reference will now be made in detail to exemplary embodiments, which are illustrated in the accompanying drawings. Wherever possible, the same reference numbers will be used throughout the drawings to refer to the same or like parts.

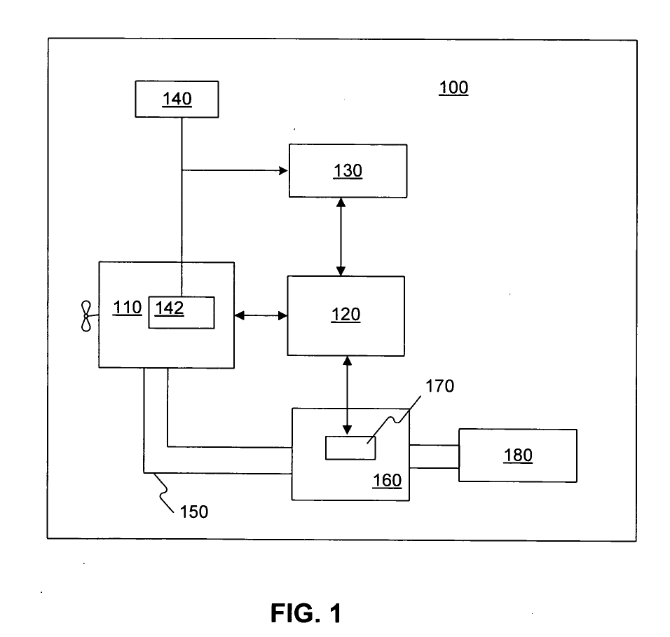

FIG. 1 illustrates an exemplary machine 100 in which features and principles consistent with certain disclosed embodiments may be incorporated. Machine 100 may refer to any type of stationary or mobile machine that performs some type of operation associated with a particular industry. Machine 100 may also include any type of commercial vehicle such as cars, vans, and other vehicles. Other types of machines may also be included.

As shown in FIG. 1, machine 100 may include an engine 110, an electronic control module (ECM) 120, a virtual sensor network system 130, and physical sensors 140 and 142. Machine 100 may also include exhaust system 150, catalyst system 160, reactant injection system 170, and muffler 180.

Engine 110 may include any appropriate type of engine or power source that generates power for machine 100, such as an internal combustion engine or fuel cell generator. ECM 120 may include any appropriate type of engine control system configured to perform engine control functions such that engine 110 may operate properly. ECM 120 may include any number of devices, such as microprocessors or microcontrollers, memory modules, communication devices, input/output devices, storages devices, etc., to perform such control functions. Further, computer software instructions may be stored in or loaded to ECM 120. ECM 120 may execute the computer software instructions to perform various control functions and processes. ECM 120 may be implemented on a field programmable gate array (FPGA) or any appropriate VLSI devices.

Although ECM 120 is shown to control engine 110 (an engine ECM), ECM 120 may also control other systems of machine 100, such as transmission systems, and/or hydraulics systems, etc. Multiple ECMs may be included in ECM 120 or may be used on machine 100. For example, a plurality of ECMs may be used to control different systems of machine 100 and also to coordinate operations of these systems. Further, the plurality of ECMs may be coupled together via a communication network to exchange information. Information such as input parameters, output parameters, and parameter values, status of control systems, physical and virtual sensors, and virtual sensor networks may be communicated to the plurality of ECMs simultaneously.

Physical sensor 140 may include one or more sensors provided for measuring certain parameters of the machine operating environment. For example, physical sensor 140 may include physical emission sensors for measuring emissions of machine 100, such as Nitrogen Oxides (NOₓ), Sulfur Dioxide (SO₂), Carbon Monoxide (CO), total reduced Sulfur (TRS), etc. In particular, NOₓ emission sensing and reduction may be important to normal operation of engine 110.

Although, as shown, physical sensor 140 is not placed in exhaust system 150, physical sensor 140 may be placed in any part of exhaust system 150 to measure NOx emission levels, such as emission levels before catalyst system 160, and emission levels after catalyst system 160, etc. Physical sensor 142, on the other hand, may include any appropriate sensors that are used with engine 110 or other machine components (not shown) to provide various measured parameters about engine 110 or other components, such as temperature, speed, acceleration rate, fuel pressure, power output, etc.

Virtual sensor network system 130 may be coupled with physical sensors 140 and 142 and ECM 120 to provide control functionalities based on integrated virtual sensors. A virtual sensor, as used herein, may refer to a mathematical algorithm or model that produces output measures comparable to a physical sensor based on inputs from other systems, such as physical sensors 140 and 142. For example, a physical NOₓ emission sensor may measure the NOₓ emission level of machine 100 and provide values of NOₓ emission level or levels of NOx emission components (e.g., NO, NO₂, etc.) to other components, such as ECM 120; while a virtual NOₓ emission sensor may provide calculated values of NOₓ emission level to ECM 120 based on other measured or calculated parameters, such as compression ratios, turbocharger efficiency, aftercooler characteristics, temperature values, pressure values, ambient conditions, fuel rates, and engine speeds, etc. The term “virtual sensor” may be used interchangeably with “virtual sensor model.”

A virtual sensor network, as used herein, may refer to a collection of virtual sensors integrated and working together using certain control algorithms such that the collection of virtual sensors may provide more desired or more reliable sensor output parameters than discrete individual virtual sensors. Virtual sensor network system 130 may include a plurality of virtual sensors configured or established according to certain criteria based on a particular application. Virtual sensor network system 130 may also facilitate or control operations of the plurality of virtual sensors. The plurality of virtual sensors may include any appropriate virtual sensor providing sensor output parameters corresponding to one or more physical sensors in machine 100.

Further, virtual sensor network system 130 may be configured as a separate control system or, alternatively, may coincide with other control systems such as ECM 120. Virtual sensor network system 130 may also operate in series with or in parallel to ECM 120.

Engine 110 may produce exhaust gas into exhaust system 150. Exhaust system 150 may include any appropriate exhaust system components associated with directing exhaust gas from engine 110 to external environment. For example, exhaust system 150 may include manifolds (not shown), a turbine (not shown), an exhaust gas recirculation system (not shown), filters, and a muffler 180, etc. In particular, exhaust system 150 may include a catalyst system 160 and a reactant injection system 170 configured to provide selective catalytic reduction (SCR) of NOx.

Using SCR, catalyst system 160 may convert NOx into diatomic nitrogen, N₂, and water, H₂O, with the aid of a reactant. Catalyst system 160 may include any appropriate types of catalysts, such as catalysts made of ceramic, titanium oxide, oxides of vanadium and tungsten, zeolites, and various precious metals, etc. Other materials, however, may also be used. Further, catalyst system 160 may also include any appropriate catalyst configuration, such as a honeycomb configuration or a plate configuration.

In operation, a reactant may be injected or spread into exhaust gas inside catalyst system 160 through reactant injection system 170 such that NOx can be converted into N₂ and H₂O to substantially reduce NOx in the exhaust gas exiting muffler 180. Reactant injection system 170 may include any components configured to inject or spread the reactant into an appropriate part of catalyst system 160, such as a plurality of nozzles to spread the reactant into different layers or plates of catalyst system 160. Although, as shown, ECM 120 may control operations of catalyst system 160 and reactant injection system 170, any appropriate controller (e.g., controllers of catalyst system 160 and reactant injection system 170 (not shown)) may be used.

The reactant used in catalyst system 160 may include any appropriate chemical compound used to react with NOx, such as anhydrous ammonia, aqueous ammonia, or urea, etc. For illustrative purposes, urea is used as the exemplary reactant to describe embodiments disclosed in this specification. When urea is used, reactant injection system 170 and catalyst 160, and other appropriate components (not shown), may be referred to as a urea SCR system. Other reactant may also be used. For example, hydrocarbon may be used for diesel fuel engine 110.

Urea is an organic compound with the chemical formula (NH₂)₂CO. In operation, urea may be combined with water and may be spread into catalyst system 160 through reactant injection system 170 to convert NOx by reacting with NOx. That is, the urea compound may decompose into ammonia (NH₃), which reacts with NOx. In addition to N₂ and H₂O, carbon dioxide (CO₂) may also be produced in catalyst system 160, as results of the conversion or reaction. Machine 100 may also include a urea tank (not shown) for carrying urea-water solution. The amount of urea solution onboard machine 100 may be limited by the tank size and may be provided by certain instruments of machine 100.

Because NOx emission consists of NO and NO₂, a total amount of urea injected into catalyst system 160 at one point of time, i.e., injection rate of urea, may be determined based on the flow rate of NOx and the ratio of NO versus NO₂. For example, an overall NOx emission level without distinguishing the NO and NO₂ components may be unable to precisely determine the total amount of urea to be injected into catalyst system 160. Therefore, the ratio of NO versus NO₂ may be important to achieve a desired operation of catalyst system 160. An error in measuring the NO/NO₂ ratio may cause an insufficient supply of urea or an oversupply of urea. An insufficient supply of urea may cause a NOx emission level exceeding an environmental regulatory threshold for NOx emission; and an over supply of urea may cause waste of urea and, more importantly, the emission of urea or NH₃ into the external environment. Although the NO/NO₂ is used for illustrative purposes, other ratios, such as NO/NOx or NO/NOx may also be used.

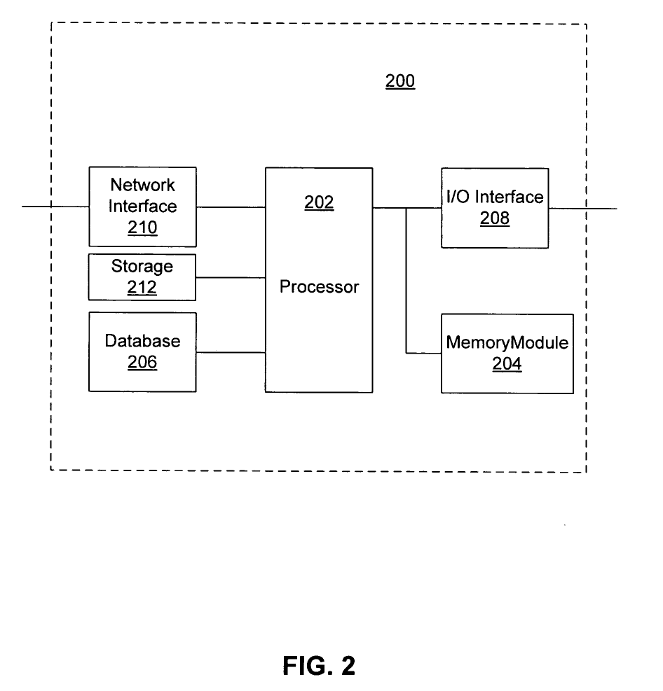

In certain embodiments, virtual sensor network system 130 may be provided to measure NO and NO₂ emission levels and/or NO/NO₂ ratio in NOx. Virtual sensor network system 130 and/or ECM 120 may be implemented by any appropriate computer system. FIG. 2 shows an exemplary functional block diagram of a computer system 200 configured to implement virtual sensor network system 130 and/or ECM 120. Computer system 200 may also include any appropriate computer system configured to design, train, and validate virtual sensors in virtual sensor network 130 and other component of machine 100.

As shown in FIG. 2, computer system 200 (e.g., virtual sensor network system 130, etc.) may include a processor 202, a memory module 204, a database 206, an I/O interface 208, a network interface 210, and a storage 212. Other components, however, may also be included in computer system 200.

Processor 202 may include any appropriate type of general purpose microprocessor, digital signal processor, microcontroller, or FPGA. Processor 202 may be configured as a separate processor module dedicated to controlling engine 110. Alternatively, processor 202 may be configured as a shared processor module for performing other functions unrelated to virtual sensors.

Memory module 204 may include one or more memory devices including, but not limited to, a ROM, a flash memory, a dynamic RAM, and a static RAM. Memory module 204 may be configured to store information used by processor 202. Database 206 may include any type of appropriate database containing information on characteristics of measured parameters, sensing parameters, mathematical models, and/or any other control information.

Further, I/O interface 208 may also be configured to obtain data from various sensors or other components (e.g., physical sensors 140 and 142) and/or to transmit data to these components and to ECM 120. I/O interface 208 may also be configured to direct data to be displayed on a console (not shown) of machine 100 via a graphic user interface (GUI).

Network interface 210 may include any appropriate type of network device capable of communicating with other computer systems based on one or more wired or wireless communication protocols. Storage 212 may include any appropriate type of mass storage provided to store any type of information that processor 202 may need to operate. For example, storage 212 may include one or more hard disk devices, optical disk devices, or other storage devices to provide storage space. Any or all of the components of computer system 200 may be implemented or integrated into an application specific integrated circuit (ASIC) or field programmable gate array (FPGA) device.

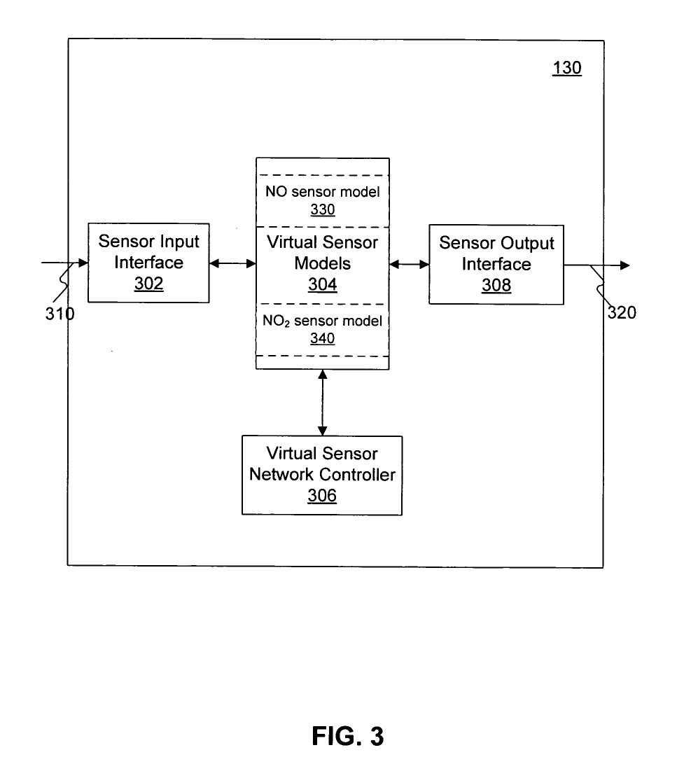

FIG. 3 shows a functional block diagram of virtual sensor network system 130 consistent with an exemplary embodiment. As shown in FIG. 3, virtual sensor network system 130 may include a sensor input interface 302, virtual sensor models 304, a virtual sensor network controller 306, and a sensor output interface 308. Input parameters 310 are provided to sensor input interface 302 and output parameters 320 are provided by sensor output interface 308.

As explained above, a virtual sensor network may refer to a plurality of virtual sensor models integrated as a collection of virtual sensors to provide sensing functionalities under a central control unit. Virtual sensor network 130 is not a simple or mechanical aggregation of multiple virtual sensor models. The plurality of virtual sensors in a virtual sensor network may be integrated to fit a particular system, and the operation of the plurality of virtual sensors may be controlled collectively.

Sensor input interface 302 may include any appropriate interface, such as an I/O interface or a data link, etc., configured to obtain information from various physical sensors (e.g., physical sensors 140 and 142). The information may include values of input or control parameters of the physical sensors, operational status of the physical sensors, and/or values of output parameters of the physical sensors. Further, the information may be provided to sensor input interface 302 as inputs 310.

Virtual sensor models 304 may include a plurality of virtual sensors, such as virtual emission sensors, virtual fuel sensors, and virtual speed sensors, etc. Any virtual sensor may be included in virtual sensor models 304. In certain embodiments, virtual sensor models 304 may include a virtual emission sensor 330 (“NO sensor model 330”) for measuring an NO portion of the NOx in the exhaust gas of engine 110, and a virtual emission sensor 340 (“NO₂ sensor model 340”) for measuring an NO₂ portion of the NOx in the exhaust gas of engine 110.

Sensor output interface 308 may include any appropriate interface, such as an I/O interface, or an ECM/xPC interface, etc., configured to provide information from virtual sensor models 304 and virtual sensor network controller 306 to external systems, such as ECM 120, or to an external user of virtual sensor network 120. The information may be provided to external systems and/or users as output 320. For example, NO emission levels, NO₂ emission levels, NOx emission levels, NO/NO₂ ratios, and/or any other sensing or control information may be provided to external systems at output 320.

A virtual sensor model may require a certain amount of computational resource to be operational. For example, a virtual sensor model may need to be stored in a certain amount of memory. The program code and data of the virtual sensor model may be loaded into memory to be executed by a processor. And the execution of the virtual sensor model may require a certain amount of processing time of the processor. Other computational resources, such as I/O operations, display operations, etc., may also be required by the virtual sensor model.

The overall computational resources required by a virtual sensor model may be referred to as a footprint of the virtual sensor model. The size of the footprint, i.e., the overall amount of the required computational resources, may relate to the complexity of the virtual sensor model, the type of the virtual sensor model, and accuracy of the virtual sensor.

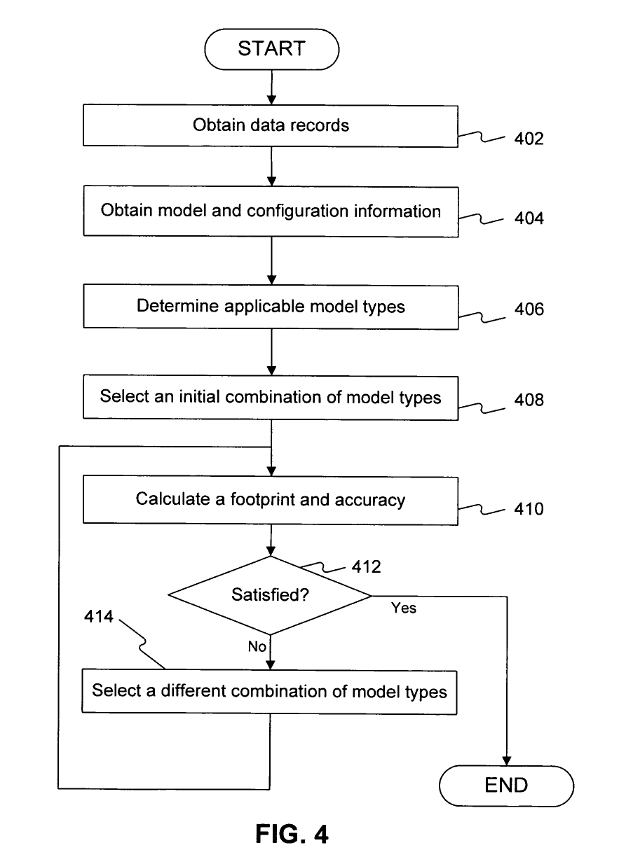

A footprint of a virtual sensor network may include footprints of all virtual sensors in the virtual sensor network plus a certain amount of computational resources required by certain virtual sensor network functionalities, such as control and validation functions. The plurality of virtual sensors may be integrated into virtual sensor models 304 of virtual sensor network system 130 by, for example, computer system 200 such that the footprint for virtual sensor network 130 may be optimized. FIG. 4 shows an exemplary integration process.

As shown in FIG. 4, computer system 200, or processor 202, may obtain data records corresponding to a plurality of virtual sensors of virtual sensor network (step 402). The data records may include, for example, information characterizing engine operations and emission levels including NO emission levels, NO₂ emission levels, NOx emission levels, and/or NO/NO₂ ratios. ECM 120 and/or physical sensors 140 and 142, such as physical NOₓ emission sensors, may be provided to generate data records, such as intake manifold temperature, intake manifold pressure, ambient humidity, fuel rates, and engine speeds, etc.

Further, the data records may be collected based on various engines or based on a single test engine, under various predetermined operational conditions. The data records may also be collected from experiments designed for collecting such data. For example, lab equipped physical sensor systems may provide data records including NO emission levels, NO₂ emission levels, NOx emission levels, NO/NO₂ ratios under various engine operational conditions, and corresponding operational parameters such as engine speed, torque, exhaust gas pressure, turbo charge and temperature, and humidity, etc. Alternatively, the data records may be generated artificially by other related processes, such as other emission modeling, simulation, or analysis processes.

The data records may include different sets of data. For example, two sets of data records may be obtained. A first set of data records may be used as training data to build virtual sensor network system 130. A second set of data may be provided as testing data to test and validate virtual sensor network 130. Other sets of data, such as simulation data and optimization data, may also be provided.

After obtaining the data records (step 402), processor 202 may obtain model and configuration information of virtual sensor models 304 including NO sensor model 330 and NO₂ sensor model 340 (step 404). The model and configuration information may include any appropriate information to establish, configure, and control the plurality of virtual sensors of virtual sensor models 304. For example, processor 202 may obtain model type information and structural information of the plurality of virtual sensors of virtual sensor models 304.

A model type may refer to mathematical characteristics of a virtual sensor model. For example, a virtual sensor model type may include a decision tree model, a linear model, a nonlinear regression model, a linear multiple regression model, a time-lag model, and a neural network model.

A decision tree model may refer to a predictive model mapping from observations about an item to conclusions about its target value. The decision tree model may include a classification tree (discrete outcome) or regression tree (continuous outcome), where tree leaves may represent certain classifications and tree branches may represent conjunctions of features that lead to those classifications.

A linear model may be represented by Y=Xβ+ε, where n and p are integers and Y is an n×1 column vector of random variables, X is an n×p matrix of “known” (i.e. observable and non-random) quantities, whose rows correspond to statistical units, β is a p×1 vector of (unobservable) parameters, and ε is an n×1 vector of “errors”, which are uncorrelated random variables each with expected value 0 and variance σ². The values of the parameters β and σ² may be inferred using a method of maximum likelihood.

A nonlinear regression model may be represented by y=b₁x¹+b₂x²+ . . . +bₙxⁿ+c, where b₁−bₙ are the regression coefficients, representing the amount the dependent variable y changes when the corresponding independent changes 1 unit. The c is the constant corresponding to where the regression line intercepts the y axis, and representing the amount the dependent y will be when the independent variable is 0. A nonlinear regression model may be used to establish that an independent variable explains a proportion of the variance in a dependent variable at a significant level and the relative predictive importance of the independent variable with respect to certain nonlinear effects.

A linear multiple regression model may be represented by y=b₁x₁+b₂x₂+ . . . +bₙxₙ+c, where b₁−bₙ are the regression coefficients, representing the amount the dependent variable y changes when the corresponding independent variables x₁ . . . xₙ change by 1 unit. The c is the constant corresponding to where the regression line intercepts the y axis, and representing the amount the dependent y will be when all the independent variables are 0. A multiple regression model may be used to establish that a set of independent variables explains a proportion of the variance in a dependent variable at a significant level and the relative predictive importance of the independent variables. Nonlinear multiple regression models can be constructed in similar fashion by applying various or multiple exponential characteristics to independent variables specified.

A time-lag model may refer to any appropriate linear or nonlinear model with a certain time lag applied to the independent variables. For instance, a simple linear model of the form y=mx+b can be transformed to a time-lagged linear model of the form yₜ=mxₜ₋ₙ+b where t represents time, and n represents desired number of lags of x in time prior to t to produce the desired estimated of y at the current time.

Further, a neural network model may refer to an interconnected group of artificial neurons (i.e., a simple processing element) that uses a mathematical or computational model for information processing based on a connectionist approach to computation. The neural network may be an adaptive system that changes its structure based on external or internal information that flows through the network. Any types of neural network models may be used. It is understood that the above model types are listed for exemplary purposes, other model types may also be used.

Structural information of a virtual sensor model may be used by processor 202 to change model type of the virtual sensor model. For example, processor 202 may change a virtual sensor model from a linear model to a neural network model. The different models corresponding to different model types may be created in real-time based on the structural information, or may be pre-established.

Processor 202 may also determine applicable model types supported by each virtual sensor model (step 406). For example, for a particular virtual sensor model, processor 202 may determine different types of models upon which the virtual sensor can be built. The models of different types may be pre-established or may be established by processor 202 in real-time.

Processor 202 may select an initial combination of model types for virtual sensor models 304 (step 408). For each of plurality of the virtual sensor models 304, processor 202 may select an initial model type. For example, processor 202 may select a neural network model for an emission virtual sensor, and may select a linear model for a temperature virtual sensor, etc. Any appropriate combination of different or same types may be used.

After selecting the model type (step 408), processor 202 may calculate a footprint and accuracy of virtual sensor models 304 (step 410). Processor 202 may calculate an individual footprint and accuracy of each of the virtual sensor models 304, and then calculate an overall footprint and accuracy of the virtual sensor models 304 based on individual footprints and accuracy. The footprint may increase in a sequential order for a decision tree model type, linear model type, nonlinear regression model type, linear multiple regression model type, time-lag linear model type, and neural network model type. Accuracy may depend upon a particular application, and may increase in a sequential order for the decision tree model type, linear model type, nonlinear regression model type, linear multiple regression model type, time-lag linear model type, and neural network model type. Accuracy criteria may also include information about model uncertainty, correlation, root-mean-square (RMS) error or other statistical measurements.

Further, processor 202 may determine whether the footprint and accuracy satisfy certain criteria or algorithms (step 412). The criteria or algorithms may be determined based upon a particular application (e.g., an engine application). For example, processor 202 may set a limitation for the overall footprint while maintaining a threshold for the overall accuracy or any individual accuracy such that a desired combination of model types may have an overall footprint under the limitation and an accuracy above the threshold. Other criteria or algorithms may also be used.

If processor 202 determines that the footprint and accuracy of virtual sensor models 304 do not satisfy the criteria (step 412; no), processor 202 may select a different combination of model types for virtual sensor models 304 (step 414). Processor 202 may select the different combination using any appropriate algorithm.

For example, processor 202 may use a genetic algorithm to select the different combination. The genetic algorithm may be any appropriate type of genetic algorithm that may be used to find possible optimized solutions based on the principles of adopting evolutionary biology to computer science, such as chromosome, selection, mutation, reproduction operations, etc.

This selecting process may continue until the genetic algorithm converges and the desired combination of model types and accuracy of virtual sensor models 304 is selected. Other algorithms, such as any progressive searching algorithm, may also be used.

On the other hand, if processor 202 determines that the footprint and accuracy satisfy the criteria (step 412; yes), processor 202 may complete the integration process and may output the desired combination model types to other control systems or users. This selecting process may be a progressive process. That is, the desired combination of model types of virtual sensor models 304 is obtained by progressively searching the various different combinations of model types of virtual sensor models 304. The desired combination of models along with other model information, such as model structures, model data, valid input spaces (i.e., valid input ranges) and output spaces (i.e., valid output ranges), calibration data, and/or other statistical data may be stored in memory or a database for operating and controlling virtual sensor models 304.

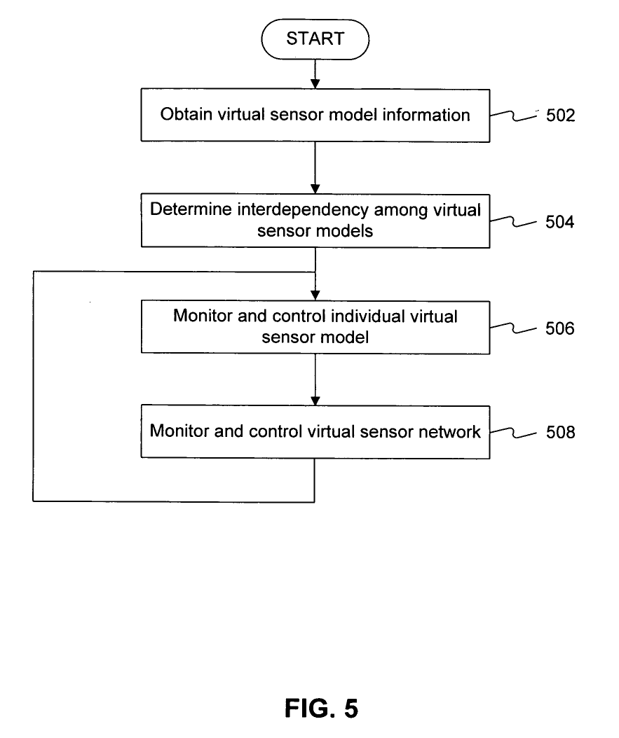

Returning to FIG. 3, virtual senor network system 130 may also include virtual network controller 306. In operation, virtual network controller 306 may monitor status of virtual sensor models 304 and corresponding physical sensors, determine fitness of individual virtual sensors of virtual sensor models 304, determine fitness of virtual sensor models 304 collectively, control operation of individual virtual sensors of virtual sensor models 304, and/or report status to other computer programs or control systems, etc. FIG. 5 shows an exemplary operation process performed by virtual sensor network controller 306 as implemented in computer system 200 or processor 202.

As shown in FIG. 5, processor 202 may obtain model information of a plurality of virtual sensors of virtual sensor models 304 (step 502). For example, processor 202 may obtain model types, model structures, model data including valid input spaces and calibration data used to train and optimize the model, and statistical data, such as distributions of input and output parameters of the virtual sensor model, etc. Processor 202 may also obtain operational data from physical sensors that provide data to or are modeled by virtual sensor models 304 via sensor input interface 302. For example, processor 202 may obtain values of input and output parameters of the physical sensors and operational status of the physical sensors.

Further, processor 202 may determine interdependency among the plurality of virtual sensor models based on the model information (step 504). Interdependency, as used herein, may refer to any dependency between two or more virtual sensor models. For example, the interdependency between two virtual sensor models may refer to existence of a feedback from one virtual sensor model to the other virtual sensor model, either directly or indirectly. That is, one or more output parameters from one virtual sensor model may be directly or indirectly fed back to one or more input parameters of the other virtual sensor model.

Processor 202 may also create a table for storing the interdependency information among virtual sensor models 304. From the interdependency table, processor 202 may look up interdependent virtual sensor models for a particular virtual sensor model or any other interdependency information in real-time.

Processor 202 may also monitor and control individual virtual sensors (step 506). For example, for a backup virtual sensor, i.e., a virtual sensor that becomes operational upon a predetermined event to replace a corresponding physical sensor, processor 202 may obtain predicted values of output parameters of the backup virtual sensor model and actual values of output parameters of the corresponding physical sensor represented by the virtual sensor model. Processor 202 may calculate a deviation between the predicted values and the actual values and may determine whether the deviation is beyond a predetermined threshold. If processor 202 determines that a deviation between the predicted values and the actual values is beyond the predetermined threshold, processor 202 may operate the virtual sensor model to provide predicted output parameter values to other control systems, such as ECM 120, via sensor output interface 308.

Further, for any operational virtual sensor model, processor 202 may obtain values of input parameters and output parameters of the operational virtual sensor. Processor 202 may further determine whether any input parameter to the virtual sensor or any output parameter from the virtual sensor exceeds the range of a valid input space or a valid output space, respectively.

If processor 202 determines that any individual input parameter or output parameter is out of the respective range of the input space or output space, processor 202 may send out an alarm to other computer programs, control systems, or a user of machine 100. Optionally, processor 202 may also apply any appropriate algorithm to maintain the values of input parameters or output parameters in the valid range to maintain operation with a reduced capacity.

Processor 202 may also determine collectively whether the values of input parameters are within a valid range. For example, processor 202 may use a Mahalanobis distance to determine normal operational condition of collections of input values. Mahalanobis distance, as used herein, may refer to a mathematical representation that may be used to measure data profiles based on correlations between parameters in a data set. Mahalanobis distance differs from Euclidean distance in that mahalanobis distance takes into account the correlations of the data set. Mahalanobis distance of a data set X (e.g., a multivariate vector) may be represented as

MDᵢ=(Xᵢ−μₓ)Σ⁻¹(Xᵢ−μₓ)′ (1)

where μₓ is the mean of X and Σ⁻ⁱ is an inverse variance-covariance matrix of X. MDᵢ weights the distance of a data point Xᵢ from its mean μₓ such that observations that are on the same multivariate normal density contour will have the same distance.

During training and optimizing virtual sensor models 304, a valid Mahalanobis distance range for the input space may be calculated and stored as calibration data associated with individual virtual sensor models. In operation, processor 202 may calculate a Mahalanobis distance for input parameters of a particular virtual sensor model as a validity metric of the valid range of the particular virtual sensor model. If the calculated Mahalanobis distance exceeds the range of the valid Mahalanobis distance range stored in virtual sensor network 130, processor 202 may send out an alarm to other computer programs, control systems, or a user of machine 100 to indicate that the particular virtual sensor may be unfit to provide predicted values. Other validity metrics may also be used. For example, processor 202 may evaluate each input parameter against an established upper and lower bounds of acceptable input parameter values and may perform a logical AND operation on a collection of evaluated input parameters to obtain an overall validity metric of the virtual sensor model.

After monitoring and controlling individual virtual sensors, virtual sensor network controller 306 (e.g., processor 202) may also monitor and control collectively a plurality of virtual sensor models (step 508). That is, processor 202 may determine and control operational fitness of virtual sensor network 130. Processor 202 may monitor any operational virtual sensor model of virtual sensor models 304. Processor 202 may also determine whether there is any interdependency among any operational virtual sensor models including the virtual sensor models becoming operational. If processor 202 determines there is an interdependency between any virtual sensor models, processor 202 may determine that the interdependency between the virtual sensors may have created a closed loop to connect two or more virtual sensor models together, which is neither intended nor tested. Processor 202 may then determine that virtual sensor network 130 may be unfit to make predictions, and may send an alarm or report to control systems, such as ECM 120, or users of machine 100. That is, processor 202 may present other control systems or users the undesired condition via sensor output interface 308. Alternatively, processor 202 may indicate as unfit only interdependent virtual sensors while keeping the remaining virtual sensors in operation.

As used herein, a decision that a virtual sensor or a virtual sensor network is unfit is intended to include any instance in which any input parameter to or any output parameter from the virtual sensor or the virtual sensor network is beyond a valid range or is uncertain; or where any operational condition of the virtual sensor or virtual sensor network makes the predictability and/or stability of the virtual sensor or the virtual sensor network undesired, such as an interdependency between two or more virtual sensors. An unfit virtual sensor network may continue to provide sensing data to other control systems using virtual sensors not affected by the unfit condition.

Processor 202 may also resolve unfit conditions resulting from unwanted interdependencies between active virtual sensor models by deactivating one or more models of lower priority than those remaining active virtual sensor models. For instance, if a first active virtual sensor model has a high priority for operation of machine 100 but has an unresolved interdependency with a second active virtual sensor having a low priority for operation of machine 100, the second virtual sensor model may be deactivated to preserve the integrity of the first active virtual sensor model.

ECM 120 may obtain output parameters (e.g., output 320, such as NOₓ emission level, NO emission level, NO₂ emission level, etc.) from virtual sensor network 130 via sensor output interface 308. ECM 120 may also obtain output parameters from mixed physical sensors and virtual sensor models. Further, ECM 120 may receive alarm or other status information from virtual sensor network 130 to adjust control parameters provided by the physical sensors and virtual sensor models to achieve desired stability and reliability.

When multiple ECMs are included, processor 202 may obtain input information, such as input parameters, from the multiple ECMs simultaneously over a communications network coupling the multiple ECMs. Processor 202 may also communicate output information, such as output parameters, to the multiple ECMs simultaneously over the communications network. Further, processor 202 may communicate status information, such as validity or fitness of the virtual sensor network to multiple ECMs simultaneously.

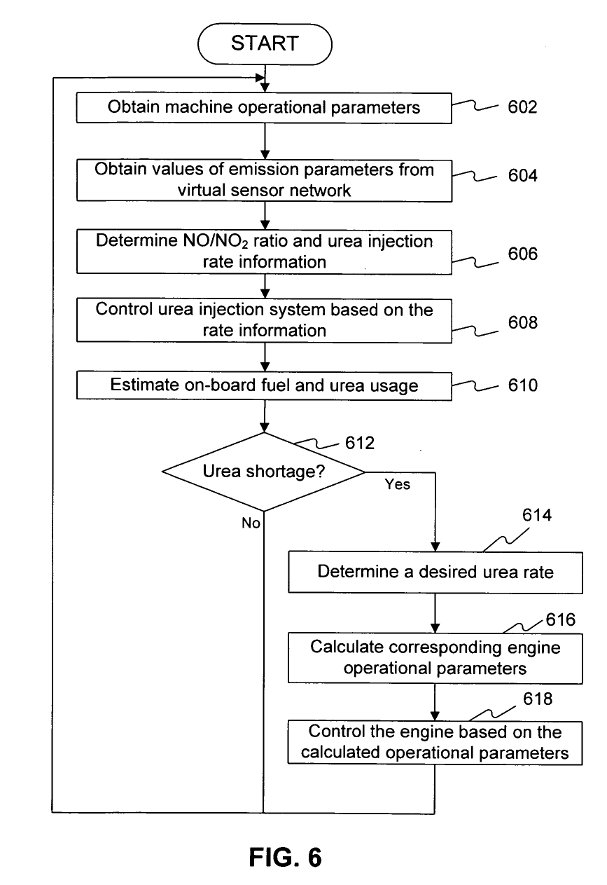

Returning to FIG. 1, in operation, ECM 120 or, if implemented by computer system 200, processor 202 may control a desired usage of urea in catalyst system 160. FIG. 6 shows an exemplary flow chart of a urea control process consistent with the embodiments.

As shown in FIG. 6, processor 202 may obtain machine operational parameters (step 602). Processor 202 may obtain engine parameters, such as engine speed, torque, engine temperature, fuel rate, fuel/air ratio, exhaust gas temperature and flow rate, etc., and virtual sensor network parameters, such as virtual sensor model data and control parameters, etc. Processor 202 may also obtain values of emission parameters from virtual sensor network 130 (step 604). For example, processor 202 may obtain NO emission levels from virtual sensor network 130 or, more specifically, from NO sensor model 330, and may obtain NO₂ emission levels from virtual sensor network 130 or, more specifically, from NO₂ sensor model 340.

Further, processor 202 may determine an NO/NO₂ ratio and urea injection rate information (step 606). Processor 202 may obtain NO/NO₂ ratio directly from virtual sensor network 130 or may determine NO/NO₂ ratio based on the NO and NO₂ emission levels from virtual sensor network 130, e.g., the NO emission level from NO sensor model 330 and the NO₂ emission level from NO₂ sensor model 340. Because the amount of urea required to be injected into catalyst system 160 to convert the NOx emission is based on the NO/NO₂ ratio and the flow rate of the NOx emission, processor 202 may determine a required urea injection rate based on the NO/NO₂ ratio and/or other available operational parameters.

After determining the urea injection rate (step 606), processor 202 may control urea injection system 170 to control urea injection based on the urea injection rate (step 608). Such urea injection rate may substantially reduce NOx emission level by converting a substantial part of the NO and NO₂ in the NOx emission using the desired amount of urea at a particular time of engine operation, and may avoid emitting un-reacted urea into the external environment.

Processor 202 may further adjust engine operation to achieve desired usages of both fuel and urea on machine 100. As explained previously, urea may be combined with water to form a solution to be injected into catalyst system 160 via reactant injection system 170. The amount of urea solution, similar to the amount of fuel, may be limited onboard machine 100, and re-supply of both urea and fuel may be required from time to time. Processor 202 may control engine operation considering both the fuel and urea usages based on a particular goal, such as maximizing operational distance of machine 100 or extending lifetime of onboard urea storage, etc.

Processor 202 may estimate on-board fuel and urea usage based on machine operational parameters (step 610). For example, processor 202 may obtain information about a total amount of on-board fuel, a current fuel rate, a total amount of on-board urea, and a current urea injection rate, etc. Based on the total amount of fuel and urea and the current rate of fuel and urea consumption, processor 202 may determine whether the urea is going to be exhausted before the fuel is exhausted. That is, processor 202 may determine whether there is a potential urea shortage (step 612).

If processor 202 determines that there is no potential urea shortage (step 612; no), e.g., urea will not be exhausted before available fuel is consumed, processor 202 may complete the urea control process. On the other hand, if processor 202 determines that there is a urea shortage (step 612; yes), e.g., urea will be exhausted before available fuel is consumed, processor 202 may determine a desired urea rate such that the shortage may be avoided (step 614). For example, processor 202 may determine the desired urea rate based on the fuel and urea information and/or other information, such as availability of refuel stations, operational conditions, operational environment, etc., such that a potential urea shortage may be avoided, or urea usage may be extended to a desired time period.

After determining the desired urea rate (step 614), processor 202 may calculate corresponding engine operational parameters under the desired urea rate (step 616). For example, processor 202 may calculate an NO/NO₂ ratio according to the desired urea injection rate such that NOx emission level would be reduced to a conforming level (i.e., below an established threshold). Further, processor 202 may determine certain engine operational parameters such that engine 110 would produce exhaust gas with the newly decided NO/NO₂ ratio.

For example, processor 202 may determine a new fuel/air ratio for engine 110 corresponding to the newly decided NO/NO₂ ratio. After calculating a fuel/air ratio based on the urea rate, processor 202 may also determine whether such fuel/air ratio is physically possible or desired for engine operation. If processor 202 is not able to find a desired fuel/air ratio that is physically possible or desired, processor 202 may notify an operator of machine 100 of such condition, and complete the urea control process without modifying engine operational parameters.

Further, after determining the corresponding engine operational parameters (e.g., fuel/air ratio, etc.) (step 616), processor 202 may control engine 110 based on the calculated engine operational parameters (step 618). By periodically adjusting engine operational parameters based on the fuel and urea information, urea usage may be extended to a maximum range supported by available fuel of machine 100. If processor 202 determines that urea is totally consumed, processor 202 may also derate the engine operation to a limp-home mode to avoid an excessive NOx level in the exhaust gas.

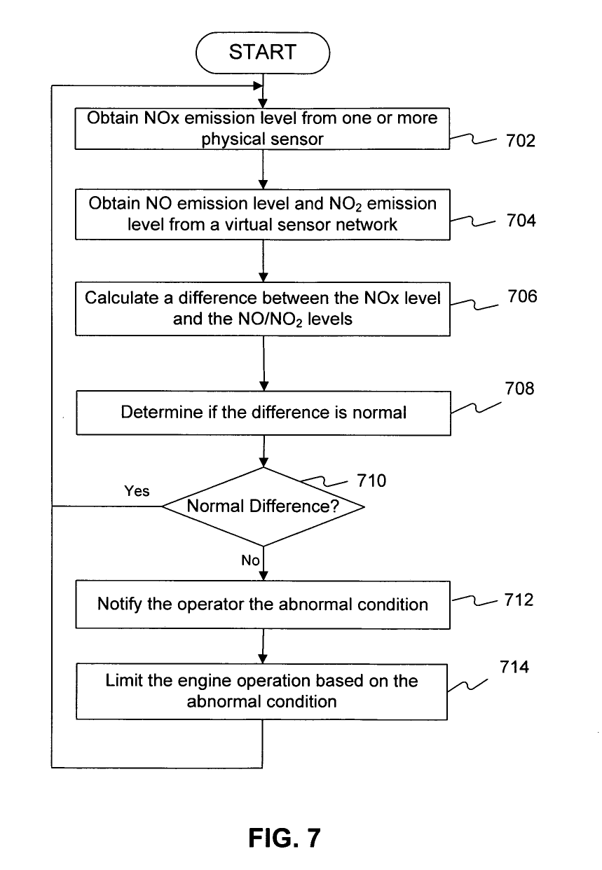

In addition to being used to control or maximize urea usage, virtual sensor network 130 may also be used to monitor or detect abnormalities associated with the urea SCR system. FIG. 7 shows an exemplary flow chart of a urea monitoring process performed by processor 202 consistent with the disclosed embodiments.

As shown in FIG. 7, processor 202 may obtain NOx emission levels from one or more physical sensors (step 702). For example, processor 202 may obtain NOx emission levels from physical sensor 140 placed before catalyst system 160 in exhaust system 150. Processor 202 may also obtain other machine operational parameters, such as the urea injection rate, etc. Further, processor 202 may obtain NO emission levels and NO₂ emission levels from virtual sensor network 130, as explained previously (step 704).

After obtaining the NOx emission level from physical sensor 140 and the NO emission level and the NO₂ emission level from virtual sensor network 130, processor 202 may calculate a difference between the NOx emission level from physical sensor 140 and the combined NO and NO₂ emission levels from virtual sensor network 130 (step 706). The difference may reflect a level of extra nitrogen component in the urea, such as NH₃, etc., and thus may reflect an actual real-time urea rate of the urea SCR system. That is, the actual urea rate according to measurements of both physical sensor 140 and virtual sensor network 130. At the same time, an instrument reading of urea injection rate may also be provided by the SCR system as the machine urea rate reading. In normal operation, the actual urea rate may be equal to, or approximately equal to, the machine urea rate reading.

Further, processor 202 may determine if the difference is normal (step 710). For example, processor 202 may compare the difference to a determined range based on the machine urea rate reading, and may determine that the difference is normal if the difference is within the determined range, and that the difference is not normal if the difference is not within the determined range (e.g., the actual urea rate does not match the machine urea rate reading). The abnormal condition may reflect that catalyst system 160 may have been tampered with, contaminated, or damaged, or may be in a condition where urea supply may be altered or contaminated.

If processor 202 determines that the difference is normal (step 710; yes), processor 202 may complete the urea monitoring process. On the other hand, if processor 202 determines that the difference is not normal (step 710; no), processor 202 may notify the operator of machine 100 to warn the operator the abnormal condition (step 712). Processor 202 may display the notification audibly or visually to the operator. Further, optionally, processor 202 may limit engine operation based on the abnormal condition (step 714). For example, processor 202 may limit or derate certain engine operations to avoid damage to engine 110 and catalyst system 160, or to avoid undesired NOx emission levels.

### INDUSTRIAL APPLICABILITY

The disclosed systems and methods may provide efficient and real-time solutions for urea based SCR systems on mobile machines. By using virtual sensor network technologies, precise application of urea may be achieved without significantly increasing manufacturing cost. Further, the disclosed systems and methods may enable conventional engine control algorithms to monitor the nitrogen oxide components and adjust the fuel/air mixture as desired to maximize the range of the mobile machine versus the consumable urea supply, or to balance the range of urea supply to the available fuel on board. The disclosed systems and methods may also provide a closed loop engine control system based on NOx emission level and/or fuel/air ratio, etc.

The disclosed systems and methods may provide an efficient and accurate solution for providing a plurality of virtual sensors within a single machine. The plurality of virtual sensors are aware of each other such that interdependency among the plurality of virtual sensors can be avoided. Fitness of individual virtual sensor model and fitness of a collection of virtual sensor models may be obtained in real-time to facilitate control systems making proper decisions corresponding to stability of the virtual sensor network.

The disclosed systems and methods may be used in many different products, such as engines, transmission equipment, other machine components and products. Further, the disclosed systems and methods may be used to provide efficient and accurate diagnostic and prognostic systems for emission systems on vehicles.

The disclosed systems and methods may also be used in electrical and electronic systems to increase robustness of the systems by improving the predictability of system failure and identifying sources for failure to enhance so-called limp-home capability. The disclosed system and methods can also change the sensor topology to minimize exposure to sensors with below-target quality and reliability. System stability and reliability may also be improved by monitoring and controlling interactions among virtual sensors that are neither considered when building individual virtual sensors nor tested after building the individual virtual sensors.

The disclosed systems and methods may be used in a wide range of virtual sensors, such as sensors for engines, structures, environments, and materials, etc. In particular, the disclosed systems and methods provide practical solutions where physical sensors are expensive to be included and/or retrofitting certain sensors is necessary. That is, the disclosed virtual sensor systems may be used to retrofit a machine with new functionalities without installing or changing new hardware devices, while such new functionalities usually require new hardware devices, such as physical sensors, to be installed. Further, the disclosed systems and methods may be used in combination with other process modeling techniques to significantly increase speed, practicality, and/or flexibility.

The disclosed systems and methods may provide flexible solutions as well. The disclosed virtual sensor network system may be used interchangeably with physical sensors. Control systems may operate based on either a virtual sensor network system or physical sensors, without differentiating data sources.

Further, the disclosed virtual sensor network system may be used to replace physical sensors and may operate separately and independently of the physical sensors in the event of failure. The disclosed virtual sensor network system may also be used to back up physical sensors. Moreover, the virtual sensor network system may provide parameters that are unavailable from a single physical sensor, such as data from outside the sensing environment.

The disclosed systems and methods may also be used by machine manufacturers to reduce cost and increase reliability by replacing costly or failure-prone physical sensors. Reliability and flexibility may also be improved by adding backup sensing resources via the disclosed virtual sensor network system. The disclosed virtual sensor techniques may be used to provide a wide range of parameters in components such as emission, engine, transmission, navigation, and/or control, etc. Further, parts of the disclosed system or steps of the disclosed method may also be used by computer system providers to facilitate or integrate other models.

Other embodiments, features, aspects, and principles of the disclosed exemplary systems will be apparent to those skilled in the art and may be implemented in various environments and systems.

What is claimed is:

1. A method for providing a selective catalytic reduction (SCR) system for reducing a pollutant emission level in exhaust gas of an engine on a machine, comprising:
providing a plurality of virtual sensors each having a model type, at least one input parameter, and at least one output parameter, wherein the plurality of virtual sensors include a first virtual sensor for measuring an emission level of a first component of the pollutant and a second virtual sensor for measuring an emission level of a second component of the pollutant;
integrating the plurality of virtual sensors into a virtual sensor network;
operating the virtual sensor network to provide the first component emission level and the second component emission level;
calculating a ratio between the first component and the second component based on the first component emission level and the second component emission level;
determining a reactant injection rate of a reactant of the SCR system based on the ratio; and
controlling the SCR system to apply the reactant at the reactant injection rate to reduce the pollutant emission level to a desired range.

2. A method according to claim 1, wherein the pollutant is NOx; the first component is NO; the second component is NO₂, and the ratio is a NO/NO₂ ratio.

3. A method according to claim 1, wherein the reactant is urea.

4. A method according to claim 1, wherein operating further includes:
determining interdependencies among the plurality of virtual sensors;
obtaining operational information of the plurality of virtual sensors;
determining a first condition under which the virtual sensor network is unfit to provide one or more virtual sensor output parameter to a control system based on the determined interdependencies and the operational information; and
presenting the determined first condition to the control system.

5. A method according to claim 2, further including:
obtaining information about a total amount of fuel and a total amount of the reactant available on the machine and a current fuel rate and a current urea rate;
determining whether there is a potential shortage of the reactant based on the information;
if it is determined that there is a potential shortage of the reactant, calculating a desired reactant injection rate to extend the usage period of the reactant; and
adjusting operation of the engine based on the desired reactant injection rate.

6. A method according to claim 5, wherein adjusting includes:
calculating a desired NO/NO₂ ratio based on the desired reactant rejection rate;
determining a desired fuel/air ratio corresponding to the desired NO/NO₂ ratio; and
adjusting the operation of the engine based on the desired fuel/air ratio.

7. The method according to claim 4, wherein integrating includes:
obtaining data records corresponding to the plurality of virtual sensors;
obtaining model and configuration information of the plurality of virtual sensors;
determining applicable model types of the plurality of virtual sensors and corresponding footprints and accuracy;
selecting a combination of model types for the plurality of virtual sensors; and
calculating an overall footprint and accuracy of the virtual sensor network based on the combination of model types of the plurality of virtual sensors. determining whether the overall footprint and accuracy is desired based on certain criteria;
if it is determined that the overall footprint and accuracy is not desired, selecting a different combination of model types for the plurality of virtual sensors; and
repeating the step of calculating the overall footprint and accuracy and the step of selecting the different combination until a desired combination of model types is determined.

8. The method according to claim 4, wherein determining the interdependencies further includes:
determining a feedback relationship between the output parameter of one virtual sensor from the plurality of virtual sensors and the input parameter of one or more of other virtual sensors from the plurality of virtual sensor; and
storing the feedback relationship in a table.

9. The method according to claim 4, wherein determining the first condition further includes:
monitoring the interdependencies of the plurality of virtual sensors; and
determining occurrence of the first condition when two or more virtual sensors are both interdependent and providing the sensing data to the control system.

10. The method according to claim 4, further including:
determining a second condition under which an individual virtual sensor from the virtual sensor network is unfit to provide the output parameter to the control system; and
presenting the determined second condition to the control system,
wherein determining the second condition further includes:
obtaining values of the input parameter of the individual virtual sensor;
calculating a validity metric based on the obtained values;
determining whether the calculated validity metric is within a valid range; and
determining the second condition if the calculated validity metric is not within the valid range.

11. A method for monitoring a selective catalytic reduction (SCR) system provided for reducing a pollutant emission level in exhaust gas of an engine on a machine, comprising:
providing a plurality of virtual sensors each having a model type, at least one input parameter, and at least one output parameter, wherein the plurality of virtual sensors include a first virtual sensor for measuring an emission level of a first component of the pollutant and a second virtual sensor for measuring an emission level of a second component the pollutant;
integrating the plurality of virtual sensors into a virtual sensor network;
operating the virtual sensor network to provide the first component emission level and the second component emission level;
obtaining a pollutant emission level of the exhaust gas from a physical sensor;
calculating a difference between the pollutant emission level from the physical sensor and a combination of the first component emission level and the second component emission level; and
determining status information of a reactant of the SCR system based on the difference to control operation of the SCR system.

12. A method according to claim 11, wherein the pollutant is NOx; the first component is NO; the second component is NO₂, and the ratio is a NO/NO₂ ratio.

13. A method according to claim 11, wherein the reactant is urea.

14. A method according to claim 13, wherein the status information includes whether the reactant is chemically altered.

15. A method according to claim 13, wherein the status information includes whether the SCR system is tampered.

16. A method according to claim 11, wherein operating further includes:
determining interdependencies among the plurality of virtual sensors;
obtaining operational information of the plurality of virtual sensors;
determining a first condition under which the virtual sensor network is unfit to provide one or more virtual sensor output parameter to a control system based on the determined interdependencies and the operational information; and
presenting the determined first condition to the control system.

17. The method according to claim 16, wherein integrating includes:
obtaining data records corresponding to the plurality of virtual sensors;
obtaining model and configuration information of the plurality of virtual sensors;
determining applicable model types of the plurality of virtual sensors and corresponding footprints and accuracy;
selecting a combination of model types for the plurality of virtual sensors; and
calculating an overall footprint and accuracy of the virtual sensor network based on the combination of model types of the plurality of virtual sensors.
determining whether the overall footprint and accuracy is desired based on certain criteria;
if it is determined that the overall footprint and accuracy is not desired, selecting a different combination of model types for the plurality of virtual sensors; and
repeating the step of calculating the overall footprint and accuracy and the step of selecting the different combination until a desired combination of model types is determined.

18. The method according to claim 16, wherein determining the interdependencies further includes:
determining a feedback relationship between the output parameter of one virtual sensor from the plurality of virtual sensors and the input parameter of one or more of other virtual sensors from the plurality of virtual sensor; and
storing the feedback relationship in a table.

19. The method according to claim 16, wherein determining the first condition further includes:
monitoring the interdependencies of the plurality of virtual sensors; and
determining occurrence of the first condition when two or more virtual sensors are both interdependent and providing the sensing data to the control system.

20. The method according to claim 16, further including:
determining a second condition under which an individual virtual sensor from the virtual sensor network is unfit to provide the output parameter to the control system; and
presenting the determined second condition to the control system,
wherein determining the second condition further includes:
obtaining values of the input parameter of the individual virtual sensor;
calculating a validity metric based on the obtained values;
determining whether the calculated validity metric is within a valid range; and
determining the second condition if the calculated validity metric is not within the valid range.

21. A machine, comprising:
an engine to provide power for the machine;
a selective catalytic reduction (SCR) system for reducing a pollutant emission level in exhaust gas of the engine
a control system for controlling the engine and the SCR system;
a plurality of physical sensors providing sensing data to the control system; and
a virtual sensor network system for providing predicted sensing data to the control system, wherein the virtual sensor network system includes a plurality of virtual sensors each having a model type, at least one input parameter, and at least one output parameter, wherein the plurality of virtual sensors include a first virtual sensor for measuring an emission level of a first component the pollutant and a second virtual sensor for measuring an emission level of a second component of the pollutant,
wherein the control system is configured to:
operate the virtual sensor network to provide the first component emission level and the second component emission level;
calculate a ratio between the first component and the second component based on the first component emission level and the second component emission level;
determine a reactant injection rate of a reactant of the SCR system based on the ratio; and
control the SCR system to apply the reactant at the reactant injection rate to reduce the pollutant emission level to a desired range.

22. A machine according to claim 21, wherein the pollutant is NOx; the first component is NO; the second component is NO₂, and the ratio is a NO/NO₂ ratio.

23. A machine according to claim 21, wherein the reactant is urea.

24. A machine according to claim 23, wherein, to operate the virtual sensor network, the control system is further configured to:
determine interdependencies among the plurality of virtual sensors;
obtain operational information of the plurality of virtual sensors;
determine a first condition, when two or more virtual sensors are both interdependent and providing the sensing data to the control system, under which the virtual sensor network is unfit to provide one or more virtual sensor output parameter to the control system based on the determined interdependencies and the operational information.

25. A machine according to claim 22, the control system is further configured to:
obtain information about a total amount of fuel and a total amount of the reactant available on the machine and a current fuel rate and a current urea rate;
determine whether there is a potential shortage of the reactant based on the information;
if it is determined that there is a potential shortage of the reactant, calculate a desired reactant injection rate to extend the usage period of the reactant; and
adjust operation of the engine based on the desired reactant injection rate.

26. A machine according to claim 25, wherein, to adjust the operation of the engine, the control system is further configured to:
calculate a desired NO/NO₂ ratio based on the desired reactant rejection rate;
determine a desired fuel/air ratio corresponding to the desired NO/NO₂ ratio; and
adjust the operation of the engine based on the desired fuel/air ratio.
